(19) United States
(12) Patent Application Publication
(10) Pub. No.: US 2006/0134282 A1
(43) Pub. Date: Jun. 22, 2006

(54) Complex coacervate encapsulate comprising lipophilic core

(76) Inventor: Michel Mellema, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/540,172

(22) PCT Filed: Nov. 17, 2003
(86) PCT No.: PCT/EP03/12886

§ 371 Date: Nov. 21, 2005

(30) Foreign Application Priority Data
Dec. 18, 2002 (EP) 020804456

(51) Int. Cl. A23G 3/20

(52) U.S. Cl. 426/282; 426/99

(57) ABSTRACT

The invention relates to a complex coacervate encapsulate comprising a lipophilic core and a hydrophilic wall, wherein the wall substantially covers the core, wherein the wall substantially consists of beta-lactoglobulin and one or more polymers having an isoelectric point below that of beta-lactoglobulin.

### FIELD OF THE INVENTION

The invention relates to a complex coacervate encapsulate comprising a lipophilic core and a hydrophilic wall, wherein the wall substantially covers the core. The complex coacervate encapsulate can be, but is not required to be totally gelatin-free. The invention further relates to a process for preparing the complex coacervate encapsulates and food compositions comprising the complex coacervate encapsulates.

### BACKGROUND TO THE INVENTION

The encapsulation of fat-soluble materials, such as bad tasting or oxygen-sensitive fats or oils, vitamins or beta-carotene is well known. Several techniques have been proposed to make an encapsulate having a lipophilic core, needed to encapsulate the fat-soluble materials.

For instance, EP 982038 describes the preparation of an encapsulate by spraying a mixture of an aqueous solution of crosslinkable protein, transglutaminase and hydrophobic material, such as beta-carotene. The crosslinkable protein is gelatin, casein, soy protein, maize protein and collagen. In the examples gelatin is used as protein.

The use of gelatin containing capsules as delivery devices is well-known in many art fields, such as paint balls, pharmaceutical gelatin capsules, vitamin/health formulations using capsules, perfume/cosmetic/bath and gel-encapsulated products. Such capsules are flexible and easily dissolved. They may be made by complex coacervation.

Complex coacervation is a well-known phenomenon in colloid chemistry, an overview of coacervation techniques for encapsulation is for example provided by P. L. Madan c.s. in Drug Development and Industrial Pharmacy, 4(1), 95-116 (1978) and P. B. Deary in “Microencapsulation and drug processes”, 1988 chapter 3. In general coacervation describes the phenomenon of salting out or phase separation of lyophilic colloids into liquid droplets rather than solid aggregates. Coacervation of a polymeric ingredient can be brought about in a number of different ways, for example a change in temperature, a change of pH, addition of a low molecular weight substance or addition of a second macromolecular substance. Two types of coacervation exist: simple coacervation and complex coacervation. In general, simple coacervation usually deals with systems containing only one polymeric ingredient, while complex coacervation deals with systems containing more than one polymeric ingredient.

Most commercially available encapsulates use animal-based gelatin to provide the needed combination of melting behaviour, flexibility and strength. However, the use of animal based gelatin has become undesirable in certain cases from the viewpoint of the transmission of diseases, such as the “mad cow” disease in Europe.

The primary sources of gelatin are from bovine animals and pigs, although fish and birds have been indicated in the literature as alternative, small volume sources of gelatin. The source of gelatin can be a problem for potential areas of use or for particular consumers. Large groups around the world do not want to ingest any products of pigs (e.g., vegetarians, the Hebrews and the Muslims) or the products of beef (the Hindus and vegetarians). As medication and/or diet supplements are provided in gelatin capsules without any indication of the source of the gelatin, the use of capsules is restricted in areas where religious beliefs would need to question the source of the gelatin. Additionally, the use of uncontrolled by-products from animals has lost some level of commercial acceptance. It has become apparent that replacement compositions for gelatin, which are not derived from animals, are desirable.

Several encapsulation techniques that do not use bovine or pig based gelatin have been proposed.

WO 96/20612 describes an encapsulate based on fish gelatin. Although fish gelatin avoids the use gelatin from bovine or pig origin, the source is still an animal source. Fish gelatin may cause allergic reactions in some people eating the fish gelatin, which complicates a general application in foods.

C. Schmitt, C. Sanchez, F. Thaoma and J. Hardy, Food Hydrocolloids 13 (1999), pages 483-496, describe the complex coacervation between beta-lactoglobulin and acacia gum in aqueous medium. This publication describes the preparation of coacervates of these ingredients, but does not teach the preparation of capsules with a lipophilic core.

WO 96/38055 describes a dry-matrix encapsulation composition comprising a flavour or active ingredient in a matrix comprising whey protein isolate. Whey protein isolate generally contains a high amount of lactose and salts.

WO 97/48288 describes an encapsulate comprising a core and a coating layer comprising protein having a mixture of hydrophobic and hydrophilic properties selected from the group consisting of isolated soy protein, whey protein isolate, caseinate and mixtures thereof. The encapsulates are produced in a process that involves denaturation of protein.

### SUMMARY OF THE INVENTION

It is an object of the invention to provide stable encapsulation of lipophilic compounds. Another object of the invention is to provide encapsulates that allow an increased bioavailability of the compounds that are encapsulated, compared to the known encapsulates. A further object is to provide encapsulates that avoid the use of gelatin as ingredient. Still a further object is to provide encapsulates having a low diameter.

One or more of these objects are attained according to the invention that provides a complex coacervate encapsulate comprising a lipophilic core and a hydrophilic wall, wherein the wall substantially covers the core, characterized in that the wall substantially consists of beta-lactoglobulin and one or more polymers having an isoelectric point below that of beta-lactoglobulin.

The encapsulation according to the invention preferably involves the use of β-lactoglobulin, a coacervating partner like caseinate and preferably a crosslinking agent like transglutaminase.

### DETAILED DESCRIPTION OF THE INVENTION

To prepare the complex coacervate encapsulate according to the invention through coacervation, β-lactoglobulin and one or more polymers having an isoelectric point below that of β-lactoglobulin are used.

The β-lactoglobulin used in the invention may be commercially available β-lactoglobulin, for instance from Sigma, Netherlands. Alternatively the β-lactoglobulin may be derived from milk products, for example from whey protein materials, such as from whey protein isolate.

The polymer having an isoelectric point (IEP) below that of beta-lactoglobulin may be any polymer, as long as it has the required IEP. This polymer may herein be designated as anionic polymer. The beta-lactoglobulin and the anionic polymers are herein collectively referred to as wall polymers.

Preferably the anionic polymer is digestible by humans. Examples of suitable digestible anionic polymers with their IEP's are: Caseines and caseinates (4.1-4.5), alpha-lactoglobulin (4.2-4.5), serum albumine (4.7), soy glycenin (4.9), soy beta-conglycenin (4.6), gum arabic, carrageenan and pectin (3-4).

The IEP of beta-lactoglobulin is 5.1-5.2.

The ratio and total concentration of biopolymers are chosen such to obtain coacervates that can form a sufficiently homogeneous and thick hydrophilic wall.

Preferably, the ratio (w/w) of beta-lactoglobulin to the total of anionic polymers is 1.5-5, preferably 1.5-3, most preferably 2-2.4.

Preferably, the ratio (w/w) of wall material materials (beta-lactoglobulin and anionic polymer(s)) to the total amount of lipophilic core material should be 0.15 or more, it is preferably higher than 0.2, and most preferably 0.25-0.5.

Preferably the beta-lactoglobulin and the anionic polymers are essentially free of salts (<0.1 (w/w) on total of dry wall polymers).

Preferably the anionic polymer comprises a caseinate or a casein derivative. Encapsulates comprising beta-lactoglobulin and caseinate according to the invention are highly susceptible towards the proteolytic activity as observed in the human stomach. Therefore their disintegration and release of the content occurs earlier as from encapsulates based on modified gelatin (crosslinked). Gelatin is known to be more resistant against the proteolytic activity of the stomach by pepsin but not against the duodenal proteases. This time difference in release between gelatin and non-gelatin encapsulates results in a faster dissolution of the encapsulated agents in the stomach contents from the non-gelatin product, resulting in a better bioavailability for compounds for which dissolution is the rate-limiting step in the bioavailability.

On the other hand the coacervates according to the invention may advantageously be used to delay the digestion of lipophilic core or components therein, compared to digestion of these components when freely dispersed in a food product.

The lipophilic core is preferably oil or an oil comprising oil-soluble or oil-dispersible compounds.

Preferably the composition of the coacervate consists of materials that are edible and applicable in foodstuffs. Preferably the complex coacervate encapsulate is stable upon preparation, processing and storage of the food formulation. Advantageously the wall of the coacervate is crosslinked, preferably the wall is crosslinked with transglutaminase.

Preferably the average particle size of the encapsulate is 50 μm or less, more preferably 10 μm or less.

The invention further relates to a process for the preparation of a complex coacervate encapsulate, wherein an emulsion of an oil-phase in an aqueous solution or dispersion of beta-lactoglobulin and one or more polymers having an isoelectric point below that of beta-lactoglobulin is subjected to a pH change, such that a complex coacervate of beta-lactoglobulin and polymer is formed.

The invention also relates to food compositions comprising complex coacervate encapsulates as described above. In such food products the coacervates are preferably present as aggregates. Preferably, the average particle size of the aggregates is between 10 and 100 μm.

According to a preferred embodiment of the invention, the lipophilic core is retained inside the hydrophilic wall during processing and/or storage, but is released upon digestion in the gastro-intestinal tract of mammals.

Stable is herein defined as leakage stability of the lipohilic compounds in the core. The leakage stability or ‘retention’ can have several advantages upon quality during processing and storage of e.g. foodstuffs containing these capsules. Advantages could be that the core is less sensitive to chemical reactions like oxidation, the core is not tasted if the formulation is eaten, and the properties of the formulation are constant during storage.

To obtain complex coacervation (at a certain pH) one of the (bio)polymer types needs to be positively charged and the other has to be negatively charged. During complex coacervation the pH is in between the respective IEPs of the biopolymers. This means that the IEP is preferably sufficiently far apart. The suitable pH for complex coacervation depends on the concentrations of biopolymers.

Most biopolymers have a low IEP, but there are few biopolymers with a high IEP. Beta-lactoglobulin has a high IEP, it is 5.1-5.2.

The β-lactoglobulin is preferably as pure as possible. Commercial whey protein isolate samples have a tendency to be rich in α-lactalbumin, salt and lactose, and such biopolymers are therefore less suitable for complex coacervation.

Another advantage of β-lactoglobulin is that it is not of animal origin (skin or bones), such as gelatin. Another advantages of β-lactoglobulin could be mentioned: The process of making complex coacervate encapsulates involves the formation of an oil-in-water emulsion. β-lactoglobulin facilitates such emulsification, compared to gelatin.

### EXAMPLES

### Examples 1-4

A. Preparation of Complex Coacervate Encapsulates

Complex coacervate encapsulates using β-lactoglobulin (ex Sigma, Netherlands) and gum arabic (ex Merck) or sodium caseinate (ex DMV, Netherlands) with synthetic β-carotene as the functional ingredient were prepared as follows:

10.5 g β-lactoglobulin and 4.9 g sodium caseinate were added to 705 g demineralised water. The mixture was heated under stirring to 55° C.

1.5 g β-carotene (30% dispersion in sunflower oil, (ex Roche, Switzerland) was put in 3 L glass cup; 43.5 g sunflower oil was added and the mixture was heated under stirring at 60° C. for 2 hours.

The oil/carotene-mixture was added to the above mentioned β-lactoglobulin solutions. The mixture was stirred with an ultraturrax (avoid foaming) at 55° C. until a good emulsion is obtained.

0.1N HCl was added until pH 5.1 was reached (while mixing with an open groove stirrer at 55° C.), coacervates were formed around the oil droplets. At the low pH the actual coacervation took place, which could visually be observed by microscopy. At this pH yield is maximal (varies with the emulsion). The time needed for acid addition has been optimised to yield small coacervateencapsulates, up to an addition time of about 60 minutes.

B. Crosslinking of Encapsulates

B1. Glutardialdehyde Crosslinking

The coacervate encapsulate mixture prepared in step A was cooled to 20 C. in 2 hours and 1.3 g glutardialdehyde (50% solution) were mixed, the resulting mixture was stirred for 18 hours at 20° C. Water was removed by filtration over a folded paper filter.

B2. Trans-Glutaminase Crosslinking

The coacervate mixture prepared in step A was cooled to 50° C. and 6.00 g transglutaminase (1% on carrier) was added and the resulting mixture was stirred for 17 hours at 50° C. The enzyme was deactivated by heating the mixture at 65° C. for 30 minutes. Subsequently the mixture was cooled to 20° C. in 2 hours and water was removed by filtration over a folded paper filter.

C. Washing of Encapsulates

Encapsulates prepared under B were washed with water to remove remains of glutardialdehyde or of trans-glutaminase. The washing step was repeated-several times in order to reduce the amount of crosslinking agent until substantially no crosslinking agent is found in the washing water.

Encapsulates were suspended in water and the mixture was stirred for 30 minutes. Water was removed by filtration over a folded paper filter. 0.1% potassium sorbate was added to the washing water.

D. Production of a Food Product (Spread) Comprising Encapsulates

Spread production was carried out at laboratory scale in a microvotator. Parameters of the spread:
β-carotene concentration in spreads was 100 mg/kg
Wetted coacervates were added of to water-phase of the spread, before joining the two phases in premix-preparation
fat-level of the spread was: 40% (w/w)

A fat blend was prepared of ingredients, amounts based on amount of fat blend:
73% bean oil
17% of an interesterified fat composition of hardened palmkernel oil
10% palm oil

This fat blend was used for the preparation of a fat phase as follows (amounts are based on total end product).
39.78% of the above fat blend
0.05% lecithin
0.16% emulsifier (diglyceride of hardened palmoil)
0.012% of a 15 wt % beta-carotene dispersion in vegetable oil

Ingredients of the aqueous phase
1.1% gelatin
0.48% NaCl
0.27% acidic whey
0.12% K-sorbate
water (balance amount)
pH was set around 5.0 with citric acid

The fat phase and aqueous phase were mixed to a pre-mix, and passed through an A-A-A-C processing line under the conditions as follows.

The premix was heated to about 60° C., and passed through the processing line for which the following conditions were applied:

A unit: 1000 rpm, at 20° C.,

A unit: 1000 rpm, at 14° C.
A unit: 1000 rpm, at 9° C.
C unit: 900 rpm
The throughput was 150 kg/hr
   E. Leakage Test
   Determination of Freely Dispersed and Encapsulated β-Carotene Concentration in a Spread

Hexane (or petroleum ether) is added to 1.3-1.9 g of spread in a flask (10-100 mL hexane, depends on β-carotene content). Mixture is shaken carefully until the fat-phase is dissolved. The encapsulates remain intact, and hexane does not extract β-carotene. Subsequently hexane is removed from the encapsulates by decantation and put in another flask. This flask is subsequently filled with hexane. Measurement of β-carotene in the hexane will give the ‘freely dispersed’ β-carotene content of the spread. Acetone is added to the remaining encapsulates. Mixture is stirred intensively until all β-carotene is extracted from the encapsulates by acetone, which is visually observed by the encapsulates becoming colourless. Measurement of β-carotene in the acetone will give the ‘encapsulated’ β-carotene content of the spread.

UV-Measurements

For measurement of encapsulated P-carotene content, the samples were filtered over a 0.22 μm filter in order to remove fine particles. For measurement of free P-carotene content samples were directly measured without filtration. Samples were measured in a 1 cm glass cuvet. The absorption maximum at wavelengths around 460 nm was used for the calculation of the β-carotene content. The following empirical formula was used:

$${C}_{β - car} = \frac{{A}_{max} \cdot V \cdot 10000}{m \cdot 2556} \qquad ( 1 )$$

with:
C_{β-car} concentration β-carotene [mg/kg]
Aₘₐₓ maximum absorption at 460 nm [−]
V volume sample [mL]
m weight of sample [g]

The leakage of β-carotene from encapsulates to the spread matrix is determined from the β-carotene in encapsulates in spreads and freely dispersed in the spread. It is calculated as follows:

$$leakage = \frac{{C}_{β - car , disp} - {C}_{β - car , init}}{{C}_{β - car , encaps} + {C}_{β - car , disp} - {C}_{β - car , init}} \cdot 100 \% \qquad ( 1 )$$

with:
C_{β-car,disp} concentration β-carotene freely dispersed in spread [mg/kg]
C_{β-car,encaps} concentration β-carotene encapsulated in spread [mg/kg]
C_{β-car,init} concentration β-carotene freely dispersed in spread, added as background colour [mg/kg]

### Examples 5-6

The procedure of examples 1-4 was repeated with the following modifications: In step A, now 10.3 g β-lactoglobulin and 4.6 g gum arabic gum were added to 678 g demineralised water. The mixture was heated under stirring to 55° C.

Comparative Experiments A-B

The procedure of examples 1-4 was repeated with the following modifications: In step AB, now 20.5 g Hyprol 8100 (whey protein isolate, containing ˜9.8 g β-lactoglobulin) and 4.9 g gum arabic were added to 720 g demineralised water. The mixture was heated under stirring to 55° C.

In examples 1-6, coacervates having an average diameter of about 10 μm were formed.

The results of examples 1-6 and comparative experiments A and B are given in table 1.

From the results reported in table 1, it is clear that when encapsulates, prepared from β-lactoglobulin and gum arabic or caseinate, are crosslinked with glutardialdehyde or transglutaminase, leakage of β-carotene is decreased considerably compared to non crosslinked encapsulates. Furthermore replacing gum arabic by caseinate has no effect on leakage of β-carotene from the crosslinked encapsulate.

Encapsulates prepared from Hyprol (comparative experiments A and B) do leak β-carotene to a high extent even after crosslinking with glutardialdehyde.

TABLE 1
Results of the rapid leakage tests of coacervate encapsulates according
to examples 1-6 and comparative experiments A-B

| | | Crosslinking | Leakage | |
|---|---|---|---|---|
| Example | Description | agent | (%) | SD |
| 1 | β-lac. + NaCas. | None | 27.1 | 2.7 |
| 2 | β-lac. + NaCas. | Glutardialdehyde | 0.7 | 0.4 |
| 3 | β-lac. + NaCas. | None | 26.8 | 0.5 |
| 4 | β-lac. + NaCas. | Transglutaminase | 1.2 | 0.06 |
| 5 | β-lac. + Gum Ar. | None | 4.6 | 0.0 |
| 6 | β-lac. + Gum Ar. | Glutardialdehyde | 1.8 | 0.6 |
| A | Hyprol^{b} + Gum Ar. | None | 49.0 | 0.5 |
| B | Hyprol^{b} + Gum Ar. | Glutardialdehyde | 54.2 | 1.9 |

β-lac.: = β-lactoglobulin.
Gum Ar.: = Gum arabic.
SD: = Standard deviation.
^{a}= Oil phase of encapsulate contains 0.05% β-carotene, whereas the other encapsulates contain 1% β-carotene in the oil phase.
^{b}= Hyprol contains 48% β-lactoglobulin.

1. A complex coacervate encapsulate comprising a lipophilic core and a hydrophilic wall, wherein the wall substantially covers the core, characterized in that the wall substantially consists of beta-lactoglobulin and one or more polymers having an isoelectric point below that of beta-lactoglobulin.

2. A complex coacervate encapsulate according to claim 1, wherein the ratio (w/w) of beta-lactoglobulin to the total of one or more polymers having an isoelectric point below that of beta-lactoglobulin is 1-5.

3. A complex coacervate encapsulate according to claim 1, wherein the polymer having an isoelectric point below that of beta-lactoglobulin comprises a caseinate or a casein derivative.

4. A complex coacervate encapsulate according to claim 1, wherein the lipophilic core is oil or an oil comprising oil-soluble compounds.

5. A complex coacervate encapsulate according to claim 1, wherein the composition of the coacervate consist of materials that are edible and applicable in foodstuffs.

6. A complex coacervate encapsulate according to claim 1, wherein the complex coacervate encapsulate is stable upon preparation processing and storage of the food formulation.

7. A complex coacervate encapsulate according to claim 1, wherein the wall is crosslinked.

8. A complex coacervate encapsulate according to claim 7, wherein the wall is crosslinked with transglutaminase.

9. A complex coacervate encapsulate according to claim 1, wherein the average particle size of the encapsulate is 50 μm or less.

10. A complex coacervate encapsulate according to claim 9, wherein the average particle size of the encapsulate is 25 μm or less.

11. Food composition comprising complex coacervate encapsulates according to claim 1.

12. Food composition according to claim 11, wherein the complex coacervate encapsulates are present as aggregates.

13. Food composition according to claim 12, wherein the preferably average particle size of the aggregates is between 10 and 100 μm.

14. Food composition according to claim 11, wherein lipophilic core is retained inside the hydrophilic wall during processing and/or storage, but is released-upon digestion in the gastro-intestinal tract of mammals.

15. Process for the preparation of a complex coacervate encapsulate, wherein an emulsion of an oil-phase in an aqueous solution or dispersion of beta-lactoglobulin and one or more polymers having an isoelectric point below that of beta-lactoglobulin is subjected to a pH change, such that a complex coacervate encapsulate of beta-lactoglubulin and polymer is formed.

16. Process according to claim 15, wherein the polymer is caseinate or a casein derivative.

17. Process according to claim 16, wherein the complex coacervate is crosslinked using a crosslinking agent.

18. Process according to claim 17, wherein the crosslinking agent is transglutaminase.
